(19) United States
(12) Patent Application Publication
(10) Pub. No.: US 2009/0055778 A1
(43) Pub. Date: Feb. 26, 2009

(54) SYSTEM AND METHOD FOR ONSCREEN TEXT RECOGNITION FOR MOBILE DEVICES

(75) Inventors: Hazem Y. Abdelazim, Cairo (EG); Mohamed Malek, Cairo (EG)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: CIT Global Mobile Division, Cairo (EG)

(21) Appl. No.: 12/196,925

(22) Filed: Aug. 22, 2008

(30) Foreign Application Priority Data
Aug. 22, 2007 (CA) 2,598,400

(51) Int. Cl. G06F 3/048

(52) U.S. Cl. 715/860

(57) ABSTRACT

The invention comprises a method of selecting and identifying on-screen text on a mobile device, comprising: a) providing an on-screen selection icon for activation of text selection mode; b) activating a text selection pointer upon activation of the selection icon; c) applying a text-selection algorithm in a region identified by user location of the text selection pointer; d) identifying text with the region using a character recognition algorithm; and, e) passing the identified text for further analysis as determined by user selection.

### FIELD OF THE INVENTION

The present invention relates to the field of computer interfaces. In particular, it relates to a screen based interface for image and word recognition for mobile devices.

### BACKGROUND OF THE INVENTION

As the consumer usage of mobile devices increases, the demand for increased functionality for these mobile devices has increased accordingly. From single-purpose mobile phones and PDAs, the market is now dominated by multipurpose devices combining features formerly found on single-purpose devices.

As mobile devices are used more often for the purpose of reading text, particular lengthy documents such as contracts, an ancillary issue has arisen in that it is currently very difficult to extract text elements from the current screen display, either to copy them into a separate document, or to subject them to further analysis (i.e. input into a dictionary to determine meaning). The issue is rendered more complex by the increase in image-based text, as images are becoming supported by more advanced mobile devices. The result is a need for a character recognition system for mobile devices that can be readily and easily accessed by the user at any time. There is a further need for a character recognition system that can identify text in any image against any background.

There are selectable OCR tools available for desktop or laptop computers (e.g. www.snapfiles.com), however these tools take advantage of the mouse/keyboard combination available to such computers. That combination is not available on mobile devices, which lack those input devices. Thus, there is a need to develop selectable OCR tools that are capable of functioning using the input devices available for mobile devices, such as styluses and touch-screens.

The recognition of a word is also simply a precursor to using the selected word in an application. Most often, the user is seeking a definition of the word, to gain greater understanding, or to input the word into a search engine, to track related documents or to find additional information. Thus, there is also a need for a mobile device character recognition system that can pass the resulting identified word to other applications as selected by the user.

It is an object of this invention to partially or completely fulfill one or more of the above-mentioned needs.

### SUMMARY OF THE INVENTION

The invention comprises a method of selecting and identifying on-screen text on a mobile device, comprising: a) providing an on-screen selection icon for activation of text selection mode; b) activating a text selection pointer upon activation of the selection icon; c) applying a text-selection algorithm in a region identified by user location of the text selection pointer; d) identifying text with the region using a character recognition algorithm; and e) passing the identified text for further analysis as determined by user selection

Preferably, the activation step comprises contacting the selection icon with a pointing device, dragging the pointing device along the screen to a desired location, and identifying the location by terminating contact between the pointing device and the screen.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a screen image representing word selection according to the present invention;

FIG. 2A is an example of touching characters “mn”;

FIG. 2B is an example of Kerning characters “fn”;

FIG. 3 is a screen image of a dictionary definition for the selected word “success”;

FIG. 4 is a screen image of a dictionary definition for the selected word “calculator”;

FIG. 5 is a screen image of a list of synonyms for the selected word “success”;

FIG. 6 is a screen image of an English-to-Arabic translation for “appointment”

FIG. 7 is a screen image of a selection screen for inputting the selected word “success” into a search engine;

FIG. 8 is a screen image of a search results screen after selecting “Google™” from the image in FIG. 7;

FIG. 9 is a histogram of color component values ordered by color component value; and

FIG. 10 is a histogram of color component values of FIG. 9 ordered by frequency.

### DETAILED DESCRIPTION OF THE PREFERRED EMBODIMENTS

The invention present herein comprises a software application which is operative to run in the background during use of a mobile device without interfering with other running software applications. Thus, the software is available for use at any time and in conjunction with any other application. While the preferred embodiment herein demonstrates a stylus-based mobile device, such as a PocketPC operating under Windows Mobile, the system and method is applicable to any mobile device and operating system.

An on-screen icon is provided which is continually ready for activation. Traditionally, such icons are located as an overlay to the primary screen image, however, it is possible for the icon to be provided as an underlay, switching to an overlay position upon activation. Thus, the icon is available to the user for activation at any time, without interfering with the current on-screen display.

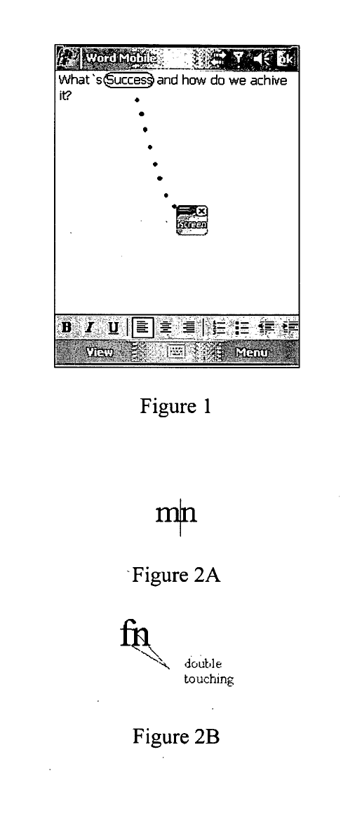

In operation, as shown in FIG. 1, the user selects the icon 100 and drags his stylus (or other pointing device) to the location 102 of the desired word 104. The user then lifts the stylus to mark the location of the desired word 104, in this example, the word selected is “success”. This dragging technique is preferred for stylus input, however, with the advent of different input methods for mobile devices, the technique can be modified for ease of use with any particular input method. For example, an alternative selection technique for use with non-stylus touch-screen interfaces is to tap and select the icon 100 and then double-tap the desired word 104.

Once a word is selected, the image pre-processing algorithm is used to extract the selected word from the surrounded background. This process enables the user to select text that is part of an image, menu box, or any other displayed element, and not limited to text displayed as text. In order to accurately select the word, the color of the word must be isolated from the color of the background. The method used for color isolation is preferably an 8 plane RGB quantization, however in some instances (e.g. non-color displays) only 4 or even 2 quantized colors are required.

### Image Pre-Processing

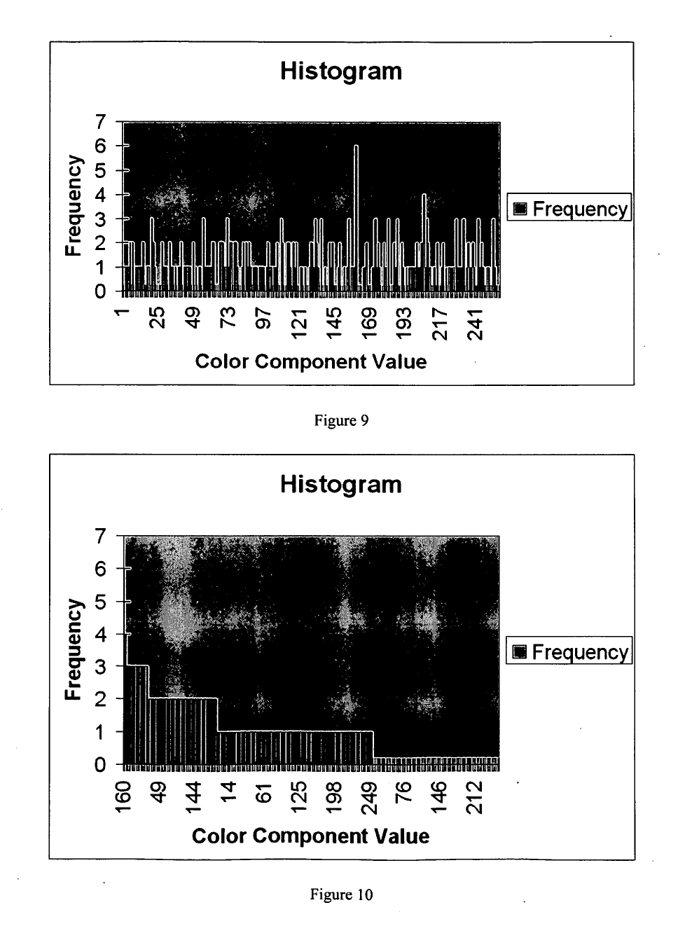

The pre-processing algorithm first starts by calculating the red, green, and blue histograms for area portions of the selection. Then the three color thresholds (red, green, blue) for each area is determined. The color threshold in this case is defined as the color with the average frequency of occurrence. Thus for each color (red, green, blue) a single color component is chosen. The choice of color component is made by taking a histogram of color component frequency, as shown in FIG. 9, and re-ordering the color components based on frequency, as shown in FIG. 10. The average occurrence value is determined according to the formula:

$$Av = \frac{( Least + Most )}{2} = ( Ex . ) \frac{( 249 + 160 )}{2} = 204.5$$

With zero occurrence components (i.e. color components not present) excluded from the calculation. Once the average occurrence value is determined, the color component in the image which is nearest that value (as the average value may not necessarily exist in the image) is chosen as the color threshold for that component.

Using these three thresholds the original image is divided into eight binary images according to Table 1.

TABLE 1

| Image | | | | |
|---|---|---|---|---|
| Index | Red | Green | Blue | Description |
| 0 | 0 | 0 | 0 | This image would contain all the pixels that have their color |
| | | | | components less than all the three color thresholds. |
| 1 | 0 | 0 | 1 | This image would contain all the pixels that have their color |
| | | | | components less than the color thresholds of the red and |
| | | | | green but larger than the blue. |
| 2 | 0 | 1 | 0 | This image would contain all the pixels that have their color |
| | | | | components less than the color thresholds of the red and blue |
| | | | | but larger than the green. |
| 3 | 0 | 1 | 1 | This image would contain all the pixels that have their color |
| | | | | components less than the color threshold of the red but larger |
| | | | | than the green and the blue. |
| 4 | 1 | 0 | 0 | This image would contain all the pixels that have their color |
| | | | | components less than the color thresholds of the blue and |
| | | | | green but larger than the red. |
| 5 | 1 | 0 | 1 | This image would contain all the pixels that have their color |
| | | | | components less than the color threshold of the green but |
| | | | | larger than the red and the blue. |
| 6 | 1 | 1 | 0 | This image would contain all the pixels that have their color |
| | | | | components less than the color threshold of the blue but |
| | | | | larger than the green and the red. |
| 7 | 1 | 1 | 1 | This image would contain all the pixels that have their color |
| | | | | components larger than all the three color thresholds. |

For each of these images a 3 by 3 pixels square erosion mask (thinning mask) is applied, as shown, for example, in Digital Image Processing by Rafael C. Gonzalez and Richard E. Woods (ISBN 978-0201508031). The erosion ratio is calculated, which is defined as the total number of points eroded (points that produced black pixels after the erosion transform) divided by the total number of points in the binary image. The most eroded image (largest erosion ratio) is selected, this image contains the candidate foreground text color. To extract the color from this image the search starts from the middle of the image (as the user is assumed to have placed the pointer centered on a word) and if this pixel is black the corresponding pixel color from the original image is the text color. If this pixel is not black then search to the right and to the left simultaneously for the first black pixel to get the corresponding pixel color from the original image to be the text color.

In some cases there can be more than one candidate text color (the erosion ratios for multiple images are the same), in these cases recognition is performed using all the found colors.

At this stage, all the images are eroded, effectively transforming the colored image into a binary image with the foreground text color and single background color. This binary image is then suitable for word and character segmentation and extraction.

### Word/Character Segmentation and Extraction

Having identified the foreground color of the text, a word scanning process starts from the point where the stylus left the screen (or whatever suitable indicator is used to identify the selected word) and travels going to the right all the way to the screen right edge limit and then from the starting position going left all the way to the left screen edge limit, searching for objects with the text foreground color.

A contour tracing process is performed to capture all objects (characters) within the scanning line. Inter character/word spacing is computed along the line, and a simple two-class clustering is performed to define a “space threshold” that is used to identify word boundaries versus character boundaries. Based on that space threshold the selected word pointed out by the user is captured. The word is isolated and each character within the word is segmented and represented by a sequence of 8-directional Freeman chain codes that represent a lossless compact representation of the character shape.

### Character/Word Recognition

In the training phase for the character and word recognition engine, large amounts of commonly used fonts and sizes are captured and encoded based on Freeman chain codes and then stored in a database. The first field in the database is the length of the chain codes along the contour of each character.

The recognition process starts by computing the length of the input character and retrieves only those samples in the database that match the character length. An identical string search is then carried out between the unknown input sample and all reference samples in the database. If a match is found then the character is recognized based on the character label of the sample in the data base.

If a match is not found then the recognition process goes to the next level where there are touching and Kerning characters. Touching characters are isolated based on trial-and-error cuts along the baseline of the touching characters, such as “mn” touching down at the junction between two characters, as shown in FIG. 2A. Kerning characters like “fn” and others (see FIG. 2B) are double touching and thus not easy to segment, and are stored as double characters. These Kerning peculiarities fortunately are not generic and comprise a few occurrences in specific fonts.

After all the characters are recognized and thus the word is recognized, the recognized word is passed on as a text for text productivity functions.

The word recognition approach is based on exact character matching unlike conventional OCR systems applied to offline scanned documents, for two reasons: 1) a high rate of accuracy can be achieved, as all the most commonly used fonts for mobile devices displays are known in advance and are more limited in number; and 2) the string search is simple and extremely fast, and does not require the overhead of conventional OCR engines, in accordance with the tolerances of the relatively low CPU speeds of mobiles and PDAs

### Text Productivity Functions

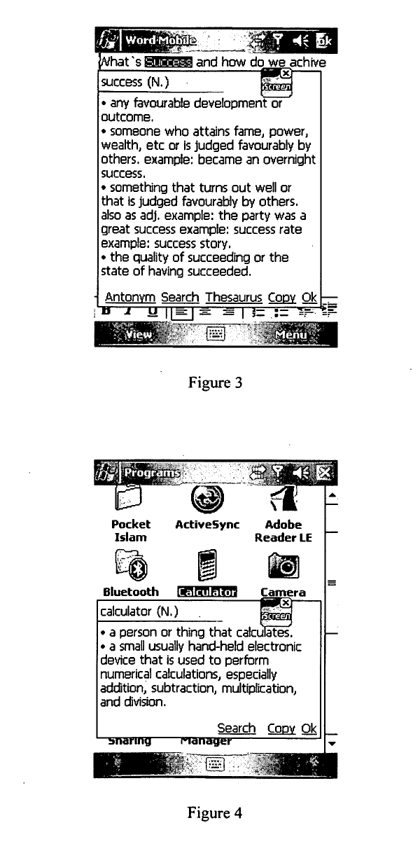

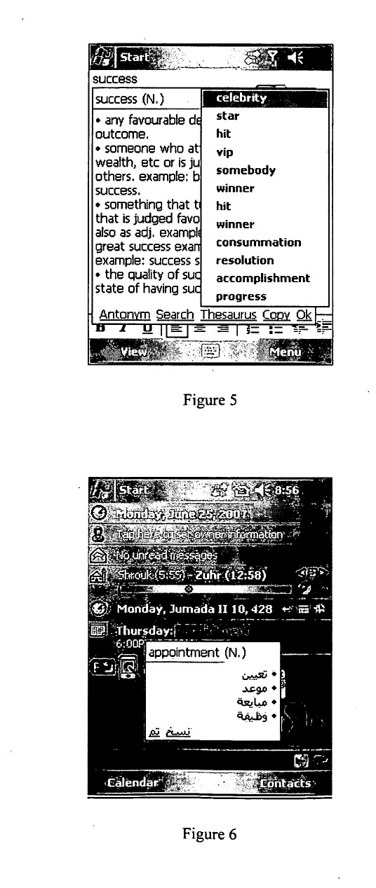

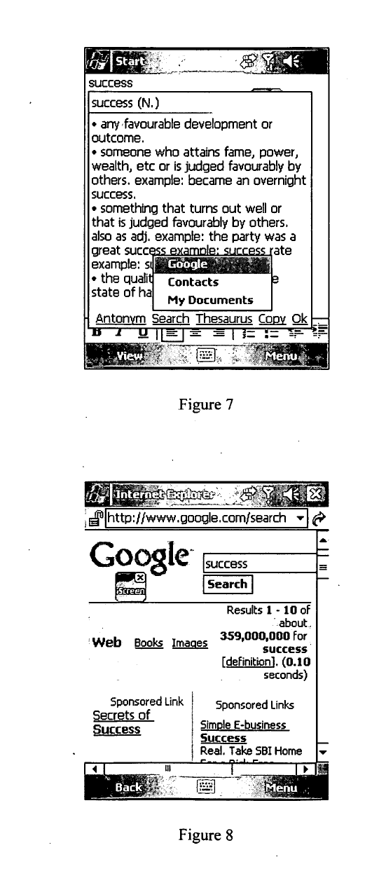

Once a word has been captured by and recognized as text, the possibilities of utilizing this input are multiplied significantly and are referred to herein as “text productivity functions”. Some example of commonly used text productivity functions include: looking up the meaning of the word (see screenshots in FIGS. 3 and 4) in a local or online dictionary; looking up synonyms and/or antonyms (FIG. 5); translating the word into another language, such as English-to-Arabic (FIG. 6); and inputting the word into a local or online search engine, i.e. Google™ (FIGS. 7 and 8). Other potential uses include looking up country codes from phone numbers to know the origin of missed calls, copying the word into the device clip board for use in another application. In general, any type of search, copy/paste or general text input function can be used or adapted to use the recognized word retrieved by the system.

Other potential, more advanced uses of the system can include server side processing for enterprise applications, text-to-speech recognition, and full-text translation. Other potential applications include assistance for users having physical impairments, such as enlarging the selected word for better readability or using text-to-speech to read out the text on the screen.

While the above method has been presented in the context of Latin characters the method is equally applicable to any character set, such as those in UTF-8.

This concludes the description of a presently preferred embodiment of the invention. The foregoing description has been presented for the purpose of illustration and is not intended to be exhaustive or to limit the invention to the precise form disclosed. It is intended the scope of the invention be limited not by this description but by the claims that follow.

What is claimed is:

1. A method of user selecting and identifying on-screen text on a mobile device, comprising:
a) providing an on-screen selection icon for activation of text selection mode;
b) activating a text selection pointer upon activation of the selection icon, the text selection pointer controllable by the user;
c) applying a text-selection algorithm in a region identified by the user location of the text selection pointer to locate text within the region; and
d) identifying the text with the region using a character recognition algorithm.

2. The method of claim 1, wherein the activation step comprises contacting the selection icon with a pointer, dragging the pointer along the screen to a desired location, and identifying the location by the final position of the pointer.

3. The method of claim 2, wherein the pointer is a stylus and the mobile device has a touch-sensitive screen.

4. The method of claim 2, wherein the pointer is one of the user's digits and the mobile device has a touch-sensitive screen.

5. The method of claim 1, wherein the text selection algorithm includes an image pre-processing step to separate the selected text from a background image.

6. The method of claim 5, wherein the image pre-processing step uses RGB color quantization to establish color thresholds for identifying foreground and background colors, and applies the color thresholds as a erosion mask to convert the selection into a binary image.

7. The method of claim 1, wherein the character recognition algorithm is based on Freeman chain codes.

8. The method of claim 7, wherein the character recognition algorithm compares Freeman chain codes for characters in the selected region against a stored database of Freeman chain codes for specific characters and fonts.

9. The method of claim 8, wherein the database further includes touching characters and Kerning characters as single Freeman chain codes.

10. The method of claim 1, further including a step e) passing the identified text to another application for further analysis as determined by the user.

11. The method of claim 10, wherein the identified text is passed to a dictionary to determine the meaning of the identified text.

12. The method of claim 10, wherein the identified text is passed to a translation engine to translate the identified text into a selected language.

13. The method of claim 10, wherein the identified text is passed as input into a search engine.
